(19) United States
(12) Patent Application Publication
(10) Pub. No.: US 2012/0088221 A1
(43) Pub. Date: Apr. 12, 2012

(54) DIGITAL ELECTRONIC TUTORING SYSTEM

(75) Inventors: Hendrik Cornells Moen, Pretoria (ZA); Derick Moolman, Pretoria (ZA)

(73) Assignee: NOVOLIBRI CC, Waterkloof Ridge, Pretoria (ZA)

(21) Appl. No.: 13/144,350

(22) PCT Filed: Jan. 14, 2010
(86) PCT No.: PCT/ZA2010/000003

§ 371 Date: Dec. 6, 2011

(30) Foreign Application Priority Data
Jan. 14, 2009 (ZA) 2009/00288

(51) Int. Cl. G09B 7/00

(52) U.S. Cl. 434/362

(57) ABSTRACT

This invention relates to an interactive, multi-sensory digital electronic tutoring system. The invention finds particular application as an electronic learning and teaching device that is configured as a digital or software “book”, preferably in a rugged slate form factor, that allows a user, normally a child, to activate electronic images, sounds and other outputs by selecting indicia displayed on a touch screen or the like and that includes programmable logic adapted to monitor and direct the child's teaching and learning experience. Central to the system is a software-derived teaching agent, presented in the form of a digital “tutor” that is integrated in the programmed logic (software) of the system in the form of an artificial intelligence (AI) system that provides a knowledge-driven, adaptive teaching and learning system that uses programming and internally- and externally derived data to adapt to the child user in a predetermined manner and that provides the child with a personalised learning process best suited to the particular child. The AI system is preferably constituted by a Self-Tuning Adaptive Control (STAC) system.

### TECHNICAL FIELD

This invention relates to an interactive, multi-sensory digital electronic tutoring system.

The invention finds particular application as an electronic learning and teaching device that is configured as a digital or software “book” that allows a user, normally a child, to activate electronic images, sounds and other outputs by selecting indicia displayed on a touch screen or the like and that includes programmable logic adapted to monitor and direct the child's teaching and learning experience.

The invention will be described with reference to such an application. It will be appreciated, however, that this is purely exemplary and it is not intended thereby to limit the invention to such an application.

### BACKGROUND ART

U.S. Pat. No. 7,402,042—Electronic learning device for an interactive multi-sensory reading system in the name of Mattel, Inc. describes and claims an electronic learning device that is configured as a folding book and that allows a child to activate electronic speech, sound and lights by selecting words or images on the covers and pages of multi-page books removably insertable in a book recess area of the electronic learning device. This patent describes typical (prior art) interactive, electronic learning systems that allow a child to activate electronic speech, sound and lights by pointing to words or images on the cover and pages of multi-page books. The principal components of such typical systems are a hinged, book-like folding base unit housing system electronics, a library of books removably mountable in a book well in the base unit and read only memory (ROM) within the base unit or within one or more cartridges removably insertable in the base unit, which cartridges store software associated with the content of the books. The child must use a hardwired stylus or pressure sensitive switches that are difficult to press to identify the page being viewed and to select the interactive content on the page. To identify a viewable page or to detect a page turn or to select interactive content, a child is typically instructed to touch, with the stylus, a uniquely positioned page identification icon, such as a graphic having a particular geometric shape or an easily recognizable key word such as the word “Go” and then the desired object of interest on the page. The patentee identifies these methods of page identification, synchronization and selection of objects as being problematic and the patent goes on to propose an alternative system, but nevertheless one which remains a relatively conventional reading aid.

### DISCLOSURE OF INVENTION

According to the invention an interactive learning and teaching system comprises:

a hardware platform;

a user interface including at least one input device adapted to convert user interaction with the hardware platform into signals capable of directing the activity of the hardware platform and at least one output device adapted to convert appropriate hardware platform signals into humanly discernable signals;

a data store adapted to store digital data and software pertaining to one or more teaching and monitoring functions;

a programmable logic device;

a teaching agent constituted by an artificial intelligence software-based process controller implemented in software in the programmable logic device;

a learning process model constituted by a data model implemented in software in the programmable logic device; and

the teaching agent being adapted to integrate the stored data and software with manual input received by way of the user interface and data derived from the learning process model and to adapt and modify the model in response to the input and data applied to the teaching agent.

In one embodiment of the invention the teaching agent artificial intelligence software is constituted by an appropriately programmed STAC system (a Self-Tuning Adaptive Control system).

The inputs to the teaching agent may be constituted by data relating to teaching and learning objectives and philosophies, which data is preferably input in a combination of manual inputs and automatic, system-derived inputs.

The hardware platform is essentially a basic computer with one or more central processing units (constituting the programmable logic device or devices described above) and a plurality of input and output devices, all combined in a relatively rugged housing.

The digital electronic tutoring system of this invention can be implemented on any one of a number of hardware platforms and for this reason the implementation of the invention in hardware is not central to this summary of the invention.

The hardware platform could of course be a relatively conventional personal computer with conventional input and output devices such as a keyboard and mouse and a display monitor.

In the preferred form of the invention however, the system is implemented on a very basic computer configured as an e-book (electronic book) or tablet PC that comprises little more than a touch screen display, which allows the user to operate the computer with one or more fingertips, audio outputs such as speakers and such other outputs (such as haptic or olfactory output devices) as cost and technology availability permit.

The hardware platform preferably includes one or more interfaces for one or more removable memory devices, such as USB ports or memory card slots, by means of which variable content and programming may be introduced to the system by means of appropriate removable memory devices.

Due to the fact that the tutoring system will normally be used by small children, the hardware platform is preferably configured as a tablet PC with a slate form factor—most rugged tablet PC models are in the slate form factor.

Also in the light of the fact that the tutoring system will be used by children, the user interface is conveniently adapted for use by and to appeal to children.

To this end, the hardware platform, under control of the programmable logic, must provide a user interface adapted to stimulate as many of the senses of the child user as is technically feasible. For this reason, the system user interface is designed to maximise user interactivity.

By way of explanation, examples of interactivity incorporated into the user interface may include the following.

Images on screen or items within an image respond to user input by changing appearance.

Images on screen or items within an image respond to user input by making a sound associated with the object in the image.

Images on screen or items within an image respond to user input by playing a video clip or animation of the object or objects in the image.

The user interface preferably includes a speech recognition/synthesis system, the system programmable logic being programmed to pose a question in a synthesized, humanly intelligible voice, for instance asking the child to identify a particular image or item within a picture, whether by using words or by making a sound associated with the object identified. Upon the system receiving user input from the child, it is adapted to acknowledge a correct or incorrect choice, followed by further instructions if appropriate.

In this example, the speech recognition/synthesis system may ask the child to imitate a particular sound or to identify an item by using words or use words to describe an action. With the use of the speech recognition/synthesis system, the system of the invention is adapted to analyse and respond to the child user's input.

Similarly, with the use of haptic technology that interfaces with the user by means of the sense of touch (by using appropriate transducers to apply forces, vibrations and/or motions to the user), the system can be adapted to develop the child user's tactile sense. An example would be an image or object in a picture that responds to user input by reproducing, in or on the transducer concerned, a texture consistent with an identified surface, for instance a furry animal skin versus a human skin.

Likewise, with the use of appropriate olfactory technology, the system can be adapted to reproduce smells to develop the olfactory senses and associations of the child user.

The above mentioned examples are not exhaustive and the term “user input” must be interpreted to refer to any form of user input appropriate to the technology in use by the system.

For instance, if the tutoring system is implemented on a touch screen computer, user input will be by way of touch on the screen and, if implemented on a PC, by way of keyboard entries or mouse clicks.

Image recognition technology provides an additional input means. Using appropriate sensors, for instance to recognize a particular child, facial expression, gesture or the like, the system can be programmed to respond in a predetermined manner.

As a further alternative and with an appropriate outer casing, the device of the invention can be programmed to change morphology or shape in response to interaction with the child, thereby providing a user input (as well as a user feedback or response) mechanism.

Underlying the hardware platform and user interface of the device, the tutoring system software is programmed to implement a number of teaching and monitoring functions, either automatically or under manual control of the child user or a supervisor, such as the child's parent, a caregiver or a teacher.

The tutoring system may conveniently be adapted to integrate various senses and actions to teach and test the child, for instance identifying an animal by speaking (by means of the speech recognition/synthesis system) the animal's name; reproducing the sounds associated with the animal; playing a video clip or animation to show the animal's actions; reproducing a touchable texture associated with the animal using haptics; and/or reproducing a smell associated with the animal.

Various teaching modes and games can be programmed, for instance a mode during which the child must touch a picture and the picture is then identified by voice, by sound, by texture, by animated action or the like.

The system may conveniently be programmed to implement a number of stimulation functions in a preprogrammed distribution pattern to stimulate the various types of intellect of the child (as posited by certain educational theorists) and the skills and senses of the child to avert boredom and to avoid having the child becoming too preoccupied in focusing on only one educational goal.

Various testing modes are possible. For instance, by storing data collected during use, play and testing by means of the system, the child user's learning progress over time can be tracked. By storing the test data of a number of child users and collating and analysing such data centrally, the child user's progress can be benchmarked against a distribution of other children. To do this, the data stored in the device must be communicated to the central location, which can be done in a number of ways, either automatically (if the device is communication-enabled) or under the manual control of the child's supervisor.

Once again this list is exemplary and not exhaustive and in each of the above and below mentioned cases, the system is programmed to store and produce reports for use by a supervisor.

Central to all of the above, is the software-derived teaching agent, presented in the form of an adaptive digital “tutor” that is integrated in the programmed logic (software) of the system.

In one embodiment of the user interface of the tutoring system, the digital tutor may conveniently be anthropomorphosised as a voice, hand, face or the like. Children tend to accept anthropomorphism (the attribution of human characteristics to non-human creatures, objects and abstract concepts) quite readily and it is believed that an anthropomorphic digital tutor will be readily accepted by a child user as a portal (possibly the principal portal) to the user interface.

A most important aspect of the tutoring system of the invention is the use of programmable logic programmed to build a profile of the learning and error patterns of the child and to adapt the teaching process implemented by the system, for instance by focusing more on identified problem areas (but not necessarily at the expense of perceived areas of greater ability).

This can be done by means of conventional data-driven teaching systems, but in the preferred form of the invention, one or more of a number of Artificial Intelligence (AI) systems may be used to provide a knowledge-driven, adaptive teaching and learning system that uses programming and internally- and externally derived data to adapt to the child in a predetermined manner and that provides the child with a personalised learning process best suited to the particular child.

### BRIEF DESCRIPTION OF THE DRAWINGS

The invention will be further described with reference to the accompanying drawings in which:

FIG. 1 is a simplified block diagram outlining the tutoring system of this invention; and

FIG. 2 is a more comprehensive block diagram of the tutoring system of FIG. 1.

### BEST MODES FOR CARRYING OUT THE INVENTION

Developments in artificial intelligence (AI) have turned up a number of software tools such as neural networks, fuzzy logic, genetic algorithms, multi-agent systems and the like that are now being integrated into whole systems, such as robotics, to realise systems that display a degree of “intelligent” behaviour.

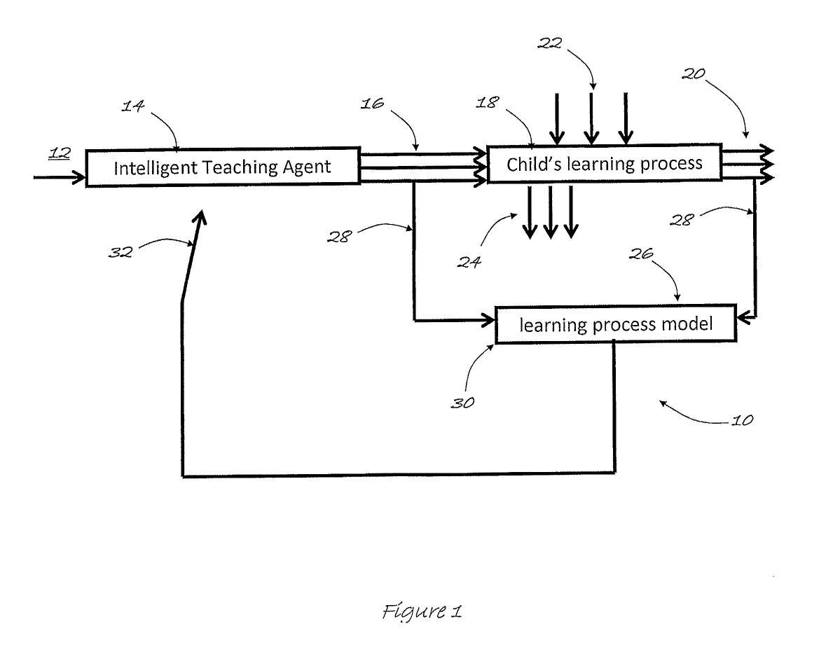

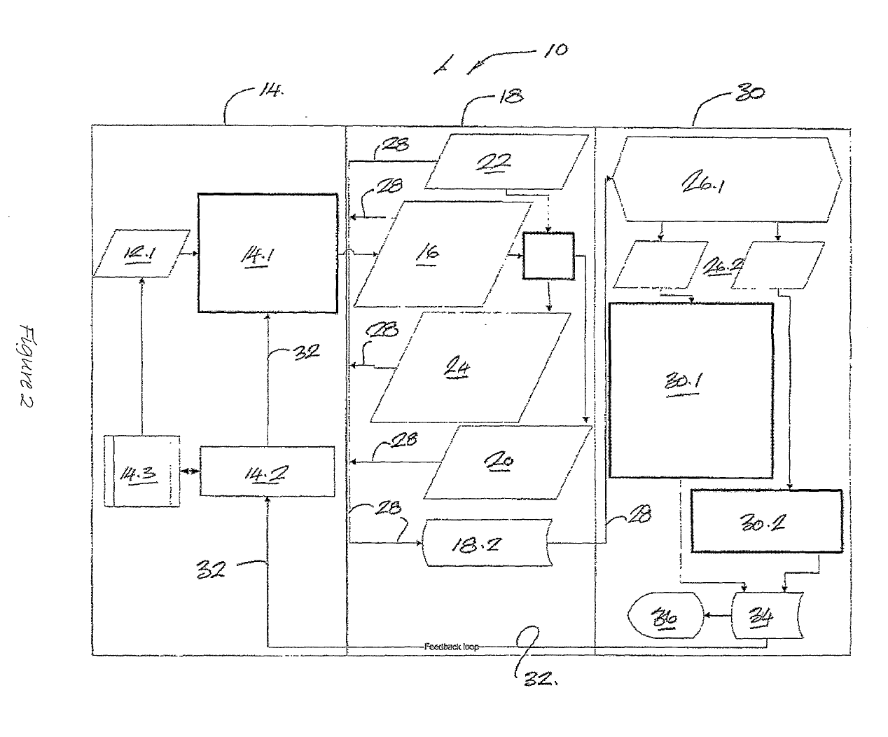

FIGS. 1 and 2 illustrate one approach to such an integrated system, in which technology analogous to a Self-Tuning Adaptive Control (STAC) system is used to provide an interactive, multi-sensory digital electronic learning and teaching system 10. STAC systems are typically used in the field of Advanced Process Control (APC) to provide dynamic, automatic modification of the control rules in use by a controller to adjust for time-varying or uncertain parameters of the system being controlled, which makes a STAC-type system uniquely suited to the system of this invention.

The simplified diagram of FIG. 1 illustrates the three main functional blocks of the tutoring system 10 of the invention as comprising an intelligent teaching agent 14, a tutoring, teaching and learning process block 18 and a learning process model 30. FIG. 2 provides a framework for a more detailed analysis of the various functional blocks.

The teaching agent 14 is the process engine of the tutoring system 10 and is constituted by an artificial intelligence software-based agent.

The inputs to the teaching agent 14 are essentially constituted by data relating to teaching and learning objectives and philosophies. This data is input manually at 12 (represented by a data block in FIG. 2). The tutoring system 10 is also programmed to provide automatic (system-derived) inputs (14.2, 14.3) to the teaching agent 14. Using a simple example, the objective could be to teach the child a set or predetermined vocabulary or certain grammatical concepts or the objective could simply be to teach certain motor skills or to develop the child's attention span in the shortest possible time.

The tutoring system 10 may be programmed with a number of teaching and learning objectives and philosophies 12 from which the supervisor merely makes a selection. Alternatively or in addition, the supervisor could enter her own objectives manually.

Alternatively or in addition, input is done by loading the tutoring system 10 with any one or more of a number of pre-defined processes 14.3 constituted by or including teaching and learning objectives based on current educational best practices or even a fully fledged educational model.

The tutoring system 10 is programmed, in a knowledge fusion process 14.2, to Integrate and consolidate knowledge about the child user (discovered by means of the tutoring system 10) with knowledge derived from the pre-defined processes 14.3 (data pertaining to current educational best practices or educational model).

All or some of the teaching objectives might be variable, either automatically (by means of system feedback 32) or by means of user configuration 12 (by the child's supervisor for instance).

The teaching agent 14 is programmed to deal with a substantial number of variables falling within the learning process functional block 18 by means of which the tutoring system 10 self-adjusts dynamically and in real time, during use of the tutoring system 10 by a child user and her supervisor. These variables include variables that are external and internal to the tutoring system 10 and, once processed, give rise to desired teaching and learning outcomes 20 that are capable of characterisation and measurement by means of the system 10.

The tutoring system 10 is programmed with a number of variables 16 (represented by a data block in FIG. 2) that the teaching agent 14 can adjust to vary the learning process 18. These adjustables include: visual stimuli; audio stimuli; touch stimuli; olfactory stimuli; association patterns; repetition pattern; rates of execution; audiovisual corrections; reward mechanisms; content selection; and games, to name but a few. The teaching agent 14 is programmed to adjust these variables in use and in real time if necessary and to supply the data 16 to the learning process 18.

No child's learning process is really ever free of disturbances and the tutoring system 10 is adapted to factor in disturbance data 22 as system variables (represented by a data block in FIG. 2). The tutoring system 10 permits both manual input and automatic measurement and recordal of predetermined disturbance data 22 as variables that might affect the learning process 18. The disturbance data 22 includes predetermined external factors such as distractions within the environment, illness on the part of the child, background noise and the like, which data must be input manually. The tutoring system 10 can also be programmed to track internal disturbance factors, like wandering attention that results in a measurable loss of concentration by the child user and which is automatically recorded by the tutoring system 10. In addition, the tutoring system 10 is programmed selectably to introduce software “noise” in the form of selectable distractions that can be used, for instance, to monitor the child's concentration and attention abilities when faced with such introduced distractions and disturbances.

The disturbance data 22 is supplied to the learning process 18.

Various states or conditions 24 relevant to the learning process 18 can be recorded manually or automatically (represented by a data block 24 in FIG. 2). These conditions may include: one or more child identifiers; the time of day; the time since the child's last sleep or to the next sleep; the child's age; one or more learning receptivity levels (which may be calculated or a manual input); session or lesson duration; duration since last session; type of session; software tools or educational philosophy or model in use; interim (non-summarized) results related to desired outcomes (useful in the modelling process 30); and more.

The learning process 18 generates a set of measurable outcomes 20 (represented by a data block in FIG. 2) that may include: correct responses recorded; correct response after a predetermined number of repetitions; response time; retention, correct response per visual, audio, touch and olfactory type; and many more, depending on the complexity of the tutoring system 10.

The data 22, 16, 24 generated by the learning process functional block 18 is applied (28) to a learning process model 30. In addition, the data 22, 16, 24 is stored in a data store 18.2 where it is time-stamped and stored, together with identification data; continuous and discrete variables; numerical and symbolic variables; and more depending on the complexity of the tutoring system 10.

In the learning process model functional block 30 the data is first prepared in a data preparation process 26.1 before appropriate modelling techniques are applied. The preparation process 26.1 involves: data organisation (including time stamping for time-series modelling); organisation of the data per user in accordance with software or educational model in use; filtering, for instance for incorrect manual data, unrepresentative sessions, false measurements (such as unintentional touches), and the like), the application of moving average-, resampling-, Boolean- and other filters; the calculation of inferred and/or fundamental or semi-empirical variables; and more.

The prepared data 26.1 is then applied to one or more process modelling engines 30.1, 30.2 that construct a model (functional block 30 in FIG. 2) that has the capacity to mimic the learning process and, alternatively or in addition, to predict all or some of the teaching and learning outcomes 20 for predetermined inputs and variables.

The modelling techniques used in the model 30 may involve both time series modelling 30.1 and discrete modelling 30.2, the latter possibly dependent on a pre-defined educational model if such a model has been used. To apply the data to the modelling processes 30.1, 30.2, the prepared data 26.1 is analysed and separated 26.2 and applied separately to the appropriate modelling process (30.1 or 30.2).

The model 30 can be used to model and determine the relationships between particular variables 16, 22 and learning outcomes 20 and, with suitable data-mining techniques, reveal useful knowledge about the learning process 18 of a particular child. Using the relationships between variables 16, 22 and outcomes, the model 30 can be used to test representative samples of variables 16, 22 to predict the learning outcomes 20 of a particular teaching and learning regimen, thereby to enable the selection of a regimen most closely matching the child's ideal learning process 18 and to select a teaching and learning regimen suitable for that child.

The model 30 can also be used to analyse causes of learning problems and as a predictor of learning problems potentially inherent in unsuitable learning and teaching processes.

Since the tutoring system 10 is self-adjusting, the model 30 is modified and refined continuously and in real time as the child user uses the system 10.

The tutoring system 10 includes a data store 34 in which data pertaining to the tutoring system 10 (such as teaching agent data, learning process data and model data) can be stored. A number of suitable digital data storage devices are available and the choice will depend on the hardware platform used for the tutoring system 10.

The teaching agent 14 is adapted to modify the control functions it applies to the learning process 18 (and hence the model 30) interactively and in real time on the basis of data extracted from the model 30 of the child's learning process 18. The extracted data is applied to the teaching agent 14 by way of a feedback loop 32 that feeds data derived from the model 30 through the knowledge fusion process 14.2 back to an “intelligent” process 14.1 forming part of the teaching agent functional block 14.

The process intelligence of the intelligent process 14.1 is derived from the implementation of one or more AI systems, which could take the form of a suitable variant of a conventional APC system, supplemented if necessary, by non-conventional APC systems and techniques, such as neural networks, expert and fuzzy logic systems, genetic algorithms, multi-agent systems and the like

The knowledge fusion process 14.2 is adapted to draw on data from one or more pre-defined processes 14.3 which it integrates and consolidates with the feedback data 32 received from the learning process model 30. The consolidated and integrated data is then applied to the intelligent process 14.1 to provide and continually enhance the adaptability of the teaching and learning controller constituted by the teaching agent 14.

The use of the knowledge fusion process 14.2 makes it possible to change the entire philosophy, educational model or teaching and learning methodology of the tutoring system 10 simply by changing one or either of the educational best practices data or the educational model or models loaded in the pre-defined process functional block 14.3.

This kind of flexibility is very important in the field of education which is replete with literature, research and controversy about educational philosophies, educational models and teaching and learning methodologies. Likewise, there are multiple models in respect of teaching and learning styles, many of them based on strongly held beliefs and teaching preferences rather than empirical evidence and as a result the adherents to such theories are extremely reluctant to adopt alternative or competing theories.

With the use of the intelligent teaching agent 14 however, the tutoring system 10 is not necessarily confined to any one educational philosophy, educational model or teaching or learning methodology. Instead, the tutoring system 10 can be used as a delivery device for educational best practices or most widely scientifically accepted educational models simply by loading and updating the appropriate programming into the pre-defined process (14.3). The tutoring system 10 is not restricted to such models however, and if desired, even the most esoteric of educational models can be used, provided the educational model is appropriately programmed into the pre-defined process 14.3. In each case, the pre-defined process 14.3 programming can be modified as new research becomes available.

Having a touch screen display, the tutoring system 10 is clearly adapted to report on and display (36) the data used in and stored on the tutoring system 10 as well as details of all aspects of the tutoring system 10, including information pertaining to the software tools or educational philosophy or model in use in the various sessions involving the system 10.

Since the tutoring system 10 records a significant number of actions of the child, the teaching agent 14 will adapt and modify the learning process 18 if a particular learning preference becomes overused and, by means of the display function 36, make it possible for the child's supervisor to take a hand in any such adaptation or modification.

With appropriate communication and network connections and hardware interfaces, the tutoring system 10 can be connected to any one of a number of devices such as a printer, a PC, data storage devices and computer networks, including the internet, the latter facilitating interactive updating of the pre-defined process 14.3 programming and benchmarking of the child user with other child users of similar age and ability.

### INDUSTRIAL APPLICABILITY

The invention finds particular application as a digital electronic learning and teaching device.

What is claimed is:

1. An interactive learning and teaching system comprising:
a hardware platform;
a user interface including at least one input device adapted to convert user interaction with the hardware platform into signals capable of directing the activity of the hardware platform and at least one output device adapted to convert appropriate hardware platform signals into humanly discernable signals;
a data store adapted to store digital data and software pertaining to one or more teaching and monitoring functions;
a programmable logic device;
a teaching agent constituted by an artificial intelligence software-based process controller implemented in software in the programmable logic device;
a learning process model constituted by a data model implemented in software in the programmable logic device; and
the teaching agent being adapted to integrate the stored data and software with manual input received by way of the user interface and data derived from the learning process model and to adapt and modify the model in response to the input and data applied to the teaching agent.

2. The interactive learning and teaching system according to claim 1, wherein the teaching agent artificial intelligence software comprises an appropriately programmed Self-Tuning Adaptive Control (STAC) system.

3. The interactive learning and teaching system according to claim 1, wherein the inputs to the teaching agent are constituted by data relating to teaching and learning objectives and philosophies, constituted by data input in a combination of manual inputs and automatic, system-derived inputs.

4. The interactive learning and teaching system according to claim 1, wherein the hardware platform is a portable computer with at least one central processing unit and a plurality of input and output devices, combined in a relatively rugged housing.

5. The interactive learning and teaching system according to claim 4, wherein the system comprises a tablet computer comprising a touch screen display and an audio output.

6. The interactive learning and teaching system according to claim 5, wherein said system is adapted for use by children, the user interface of the system being adapted for use by and to appeal to children in that the hardware platform, under control of the programmable logic, is adapted to provide a user interface adapted to stimulate a multiplicity of the senses of the user.

7. The interactive learning and teaching system according to claim 6 including a speech recognition/synthesis system, the system programmable logic being programmed to output one or more pre-programmed statements in a synthesized, humanly intelligible voice, to receive voice command input from the user; and to acknowledge or respond to the user input either or both visually and audibly.

8. The interactive learning and teaching system according to claim 6 including haptic technology adapted to interface with the user by means of the sense of touch, the system including at least one transducer adapted to apply at least one of a force, a vibration and motion to the user.

9. The interactive learning and teaching system according to claim 7 including olfactory technology, the system being adapted to reproduce signals adapted to stimulate the olfactory sense of the user.

10. The interactive learning and teaching system according to claim 7, wherein the outer casing of the hardware platform is adapted to change morphology or shape in response to interaction with the user.

11. The interactive learning and teaching system according to claim 1, wherein the programmable logic device includes tutoring software programmed to implement, by means of the hardware platform, at least one of a plurality of stimulation functions in a preprogrammed distribution pattern to stimulate the various types of intellect of the user.

12. The interactive learning and teaching system according to claim 1, wherein the programmable logic device includes user testing software, the programmable logic device being adapted to store data collected during one or more of use, play and testing by means of the system, to enable analysis of the user's learning progress over time.

13. The interactive learning and teaching system according to claim 12, wherein the programmable logic device is programmed to record data about the user's interaction with the system and to develop and record a profile of the learning and error patterns of the user, the programmable logic device being adapted to adapt the teaching process implemented by the system in accordance with pre-programmed profile parameters.

14. The interactive learning and teaching system according to claim 13, wherein the programmable logic device is programmed with an Artificial Intelligence (AI) system adapted to provide a knowledge-driven, adaptive teaching and learning system that uses programming and internally and externally derived data to adapt to the user in a predetermined manner.

15. The interactive learning and teaching system according to claim 1, wherein the user interface of the tutoring system is anthropomorphosised as a voice, hand, face or the like.

16. The interactive learning and teaching system according to claim 1 that is adapted to communicate with a remote location.
